(19) United States
(12) Patent Application Publication
(10) Pub. No.: US 2009/0063533 A1
(43) Pub. Date: Mar. 5, 2009

(54) METHOD OF SUPPORTING MULTIPLE EXTRACTIONS AND BINDING ORDER IN XML PIVOT JOIN

(75) Inventor: Edison Lao Ting, San Jose, CA (US)

Correspondence Address: Kunzler & McKenzie, 8 EAST BROADWAY, SUITE 600, SALT LAKE CITY, UT, 84111, US

(73) Assignee: International Business Machines Corporation, Armonk, NY (US)

(21) Appl. No.: 11/845,556

(22) Filed: Aug. 27, 2007

(51) Int. Cl. G06F 17/30

(52) U.S. Cl. 707/102; 707/E17.123

(57) ABSTRACT

An apparatus and method are disclosed for finding and returning sub-trees from within a preselected XML document that match an XQuery FLWOR expression having a binding order, in which a match graph is generated from an XML index of node paths for a collection of XML documents, where the collection includes the preselected XML document and the match graph is first traversed by a plurality of cursors in a reverse binding order and traversed by the plurality of cursors in forward binding order.

### BACKGROUND OF THE INVENTION

1. Field of the Invention

This invention relates to the evaluation of XQuery ‘FLOWR’ Expressions using XML Indexing Technologies. In particular, this invention describes use of XML Indexing Mechanisms used during XML Pivot Join (as known as XANDOR for XML Anding and ORing) to support the evaluation of XQuery ‘FLWOR’ Expressions over a collection of XML documents, supporting Multiple Extractions and Binding Order.

2. Description of the Related Art

XPath and XQuery are two common languages used to query XML documents. XPath is a path expression language for selecting and extracting data within XML documents. An XPath expression is comprised of steps where each step specifies an axis, specifying the direction of evaluation from the current context node (i.e. child or descendant, etc.), and a node test specifying the kind and name of nodes within the current XML document to select and/or extract from, and predicates that limit the selection of these nodes.

XQuery is a language for querying, iterating (i.e. FOR), aggregating (i.e. LET), transforming, and constructing XML data. XQuery uses XPath to address specific parts of XML documents and is semantically similar to structured query language (SQL). A typical SQL-like XQuery syntax uses “For, Let, Where, Order by, and Return” clauses in a “FLWOR” expression.

The XML pivot join procedure takes a collection of XML documents and returns only those documents that satisfy some XPath Expression. The XML pivot join procedure uses XML index scans to filter XML index entries that match legs of a XPath expression. For example, the XPath expression, “/a/b[(c=5) AND (d=6)],” selects ‘b’ element nodes within XML documents whose parent element node is ‘a’, and whose immediate child node c=5 and child node d=6. The resulting output ‘b’ element nodes will be from qualifying XML documents that satisfy the conditions of the XPath expression.

Several intermediate structures may be created to fulfill an XML pivot join request. A query tree may be generated, from the query, which describes the query in tree representation. A paths table may be created, from the collection of XML documents, to describe every unique path within each document, including paths that are non-relevant to the query. Next, entries from the paths table may be matched against the query tree and qualifying paths may be combined to form a paths tree. Finally, a match graph is constructed by finding paths in the paths tree that match steps in the query tree.

In the present art, XML Pivot Join implementations can provide either inter-document level filtering or return single extractions (e.g. a single set of results) based on an XPath query. However, current XML Pivot Join implementations fail to permit multiple extractions and provide improper results due to failure to respect binding order for an XQuery FLWOR expression. Throughout this specification the terminology ‘extraction’ means a document or a portion of a document retrieved from a single document or group of documents, where this retrieval is based on the document or document portion matching specified criteria.

### SUMMARY OF THE INVENTION

Applicants assert that a need exists for a method and apparatus that properly handles a evaluation of XQuery FLWOR (for-let-where-return) expressions that require returning of Multiple Extractions from a preselected XML document, as well as the support for binding order thereby extending an XML pivot join procedure by providing both inter-document level filtering as well as intra-document level filtering.

The present invention has been developed in response to the present state of the art, and in particular, in response to the problems and needs in the art that have not yet been fully solved by currently available XQuery FLWOR expression handling techniques. Accordingly, the present invention has been developed to provide an apparatus, system, and method for handling multiple extractions, properly handling of FOR and LET bindings, as well as the support for binding order compliance during an XML pivot join procedure.

Given an XQuery FLWOR expression, XML indexes are used to identify locations within XML documents that satisfy the query as a whole, taking into account structural constraints specified in XPath expression fragments within the FLWOR expression, and handling the semantics specified by FOR and LET bindings, and supporting binding order specified by the FOR bindings. Note that binding order may be specified by an optimizer rather than the original query, because the optimizer may determine an order for the bindings that optimizes query evaluation performance.

Preferably, inter-document level filtering is accomplished first to reach a candidate XML document that matches the XQuery FLWOR expression, then Intra-document level filtering is accomplished by finding sub-trees within the document that match the XQuery FLWOR expression.

Conventional techniques lack an XML indexing algorithm that supports XQuery FLWOR expressions in the manner of the present invention. Those skilled in the art will appreciate that the present invention replaces the combined functionality of an XML Indexing component that filters XML documents in a collection and a XML Evaluation engine that actually processes the an XML document given a XQuery expression.

In one embodiment, a computer system includes program code adapted to filter a collection of XML documents for documents that satisfy an XQuery FLWOR expression and extract document nodes referred to by the XPath expressions in the XQuery FLWOR expression while honoring binding order specified in the XQuery FLWOR expression.

The program code first provides an XML index of node paths for a collection of XML documents and an XQuery FLWOR expression having a plurality of “FOR or LET” bindings where the plurality of “FOR or LET” bindings further comprise one or more “FOR” and one or more “LET” bindings. The program code next generates a path tree and a match graph according to the XQuery FLWOR expression and based on a set of linear XPaths identified in the XQuery FLWOR expression as well as a set of node paths in the collection of XML documents that match the steps of the linear XPaths. Next, the program code positions and advances a plurality of index cursors, where each index cursor points to a match for a linear XPath step, each match is represented by a match node in the match graph, and each match refers to a document node location in the collection of XML documents. The plurality of index cursors includes an inner cursor and an outer cursor and each of the cursors points to one of the “FOR or LET” bindings in the XQuery FLWOR expression. The first result, the node locations pointed to by the cursors is returned by the program code.

The program code is further adapted to advance the inner cursor along the match graph in reverse binding order, responding to the advancing inner cursor pointing to a step match by returning subsequent result sets, and when the inner cursor doesn't find a match step by advancing an outer cursor in reverse binding order. The outer cursor is advanced in a similar manner and additional node sets are returned.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 shows XPath tree representations of a first group of XML documents making up a collection;

FIG. 2 shows an XPath tree representation of an additional XML document included in the collection of FIG. 1;

FIG. 3 shows a query tree representation of an XPath query;

FIG. 4 shows a paths tree derived from the collection of XML documents shown in FIGS. 1 and 2; and

FIG. 5 shows a match graph derived from the paths tree of FIG. 4 according to the query tree of FIG. 3;

FIG. 6 illustrates index cursors being positioned within a match graph representing XML documents in accordance with one illustrative embodiment of the present invention;

FIGS. 7 through 10 shows index cursors progressing through the match graph of FIG. 6 and obtaining answers according to the present invention;

FIGS. 11 through 13 illustrates a match graph including recursive entries, index cursors progressing through this recursive match graph, and obtaining answers according to a further embodiment of the present invention; and

FIG. 14 shows an even further embodiment of the present invention that includes “LET” bindings.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment”, and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

### XML Pivot Join

An XML Pivot Join provides an efficient way to filter a collection of XML Documents for documents that satisfy some XPath/XQuery expression. For example, given XPath /a/b[c=5 and d=6] and a collection of XML documents. In certain embodiments, the XML Pivot Join method performs index ‘ANDing’ on two XML Index Scans, one XML Index scan on /a/b/c=5 and one XML Index scan on /a/b/d=6. In this case, the XML Pivot Join method advances the scans of one leg based on the location information of scans of another and vise-a-versa. If the scan on /a/b/c=5 returns the location document 5 nodeID 1.1.2.3 (saying that document 5 has a path a-b-c such that c's value is 5, then the next location we need to look for to satisfy the expression /a/b/d=6 has to be at least at document 5 and below that a-b path at document 5 (since we're looking for a a-b-d path where d's value is 6). If the node c on the a-b-c path that satisfied /a/b/c=5 at document 5 has the nodeID of 1.1.2.3, then the nodeID of b for the a-b path is 1.1.2. This means the scan for /a/b/d=6 has to start at least at the location document 5, nodeID 1.1.2. Intuitively this means that since we've found a a-b-c path at document 5, we need to look for a d under that a-b path under document 5 where the a-b-d path=6. If we find a match for /a/b/d=6 at document 5 nodeID 1.1.2.4 for instance, then we've found a document that satisfies /a/b[c=5 and d=6]. If the next location for /a/b/d=6 is some node at document 7, then the index scan for /a/b/c=5 now needs to be advanced to some location at document 7, so the algorithm advances either of the legs until a matching document location and node location is found.

We will now describe in detail how XML Pivot Join filters XML documents given some regular XPath expression, and in the process describe the necessary structures used in XML Pivot Join.

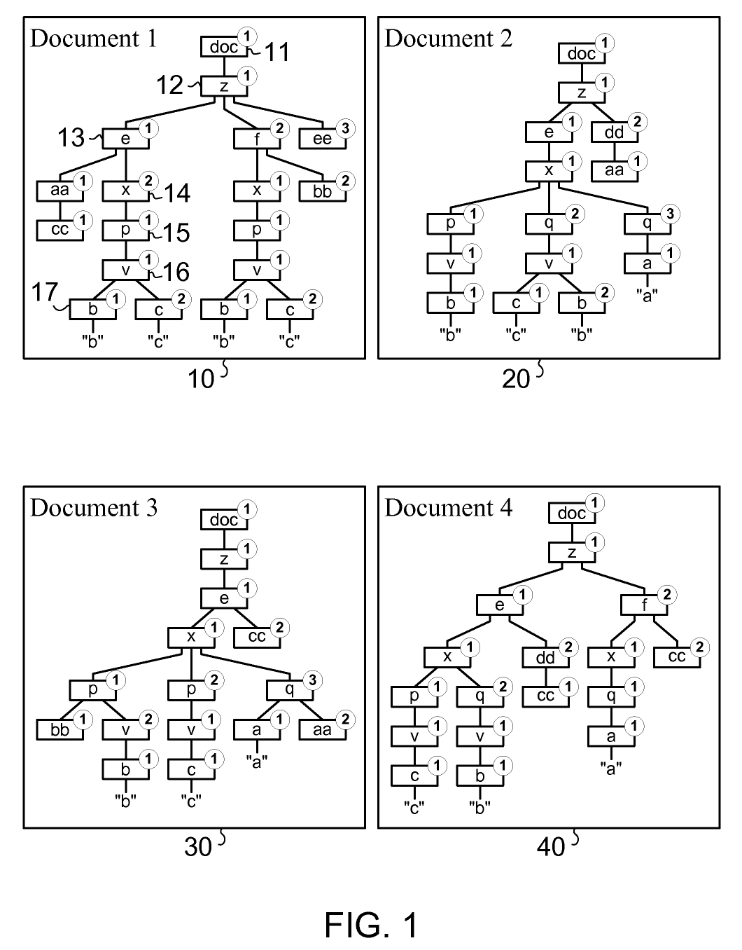

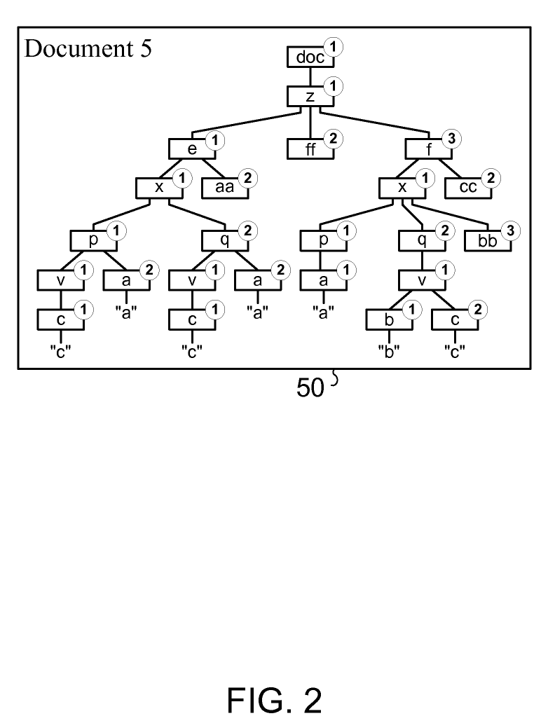

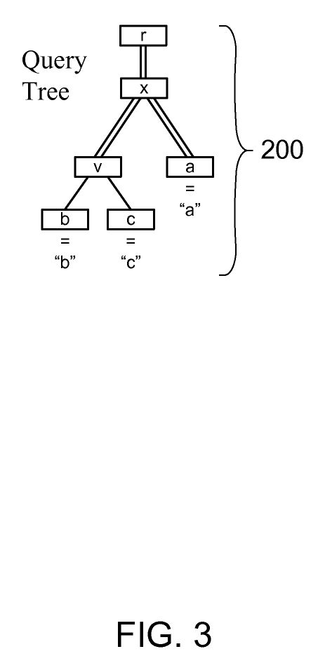

Refer first to FIGS. 1 and 2, which illustrate certain example XML documents in XPath tree format and the example XPath query shown below in Expression 1. This XPath query is illustrated as a query tree 200 in FIG. 3.

//x[.//v[b=‘b’ and c=‘c’] and .//a=‘a’ Expression 1:

The double lines in query tree 200 represent the descendant axis steps and the single lines represent child axis steps.

A paths table corresponding to document 1 (10), document 2 (20), document 3 (30), document 4 (40), and document 5 (50) is listed below. The Paths Table uniquely identifies all the Paths that exist in a collection of XML documents. For the example documents of FIGS. 1-2, the Paths Table below can be derived. Notice that there are paths in the paths table which are not relevant to the query. The z-e-aa-cc path for example is not relevant to the XPath //x[.//v[b=“b” and c=“c”] and .//a=“a”], but the z-e-x-p-v-b path is because it matches the linear XPath //x[.//v[b=“b”]].

TABLE 1
Paths Table

| Document 1 | Document 2 | Document 3 | Document 4 | Document 5 |
|---|---|---|---|---|
| (10) | (20) | (30) | (40) | (50) |
| z-e-aa-cc | z-e-x-p-v-b | z-e-x-p-bb | z-e-x-p-v-c | z-e-x-p-v-c |
| z-e-x-p-v-b | z-e-x-q-v-c | z-e-x-p-bb | z-e-x-q-v-b | z-e-x-p-a |
| z-e-x-p-v-c | z-e-x-q-v-b | z-e-x-p-bb | z-e-dd-cc | z-e-x-q-v-c |
| z-f-x-p-v-b | z-e-x-q-a | z-e-x-p-v-b | z-f-x-q-a | z-e-x-q-a |
| z-f-x-p-v-c | z-dd-aa | z-e-x-p-v-c | z-f-cc | z-e-aa |
| z-f-bb | — | z-e-x-q-a | — | z-ff |
| z-ee | — | z-e-x-q-aa | — | z-f-x-p-a |
| — | — | z-e-cc | — | z-f-x-q-v-b |
| — | — | — | — | z-f-x-q-v-c |
| — | — | — | — | z-f-x-bb |
| — | — | — | — | z-f-cc |

Now reference FIG. 3, which shows a paths tree 300 that has been created from the query tree 200 and paths table, above. This paths tree 300 summarizes all the XPaths in the collection of XML documents (10, 20, 30, 40, and 50) that are relevant to the reference query (Expression 1). The set of every linear XPath in the XPath query, that is for the XPath query //x[.//v[b=“b” and c=“c”] and .//a=“a”], by the linear XPaths listed below.

1. //x[.//v[b=“b”]], which is XPath //x//v/b

2. //x[.//v[c=“c”]], which is XPath //x//v/c

3. //x[.//a=“a”], which is XPath //x//a

From these linear XPaths, we find matching paths in the paths table. The paths found are used to build the paths tree 300, which shows matching paths for each linear XPath and shows where paths may have common ancestors in the collection of documents. For example, the path z-e-x-p-v-b, which matches linear XPath //x//v/b, shares a common path segment z-e-x-p-v with the path z-e-x-p-v-c, which matches linear XPath //x//v/c. This means there may be some set of paths z-e-x-p-v-b z-e-x-p-v-c within the collection of documents whose location at z-e-x-p-v matches (e.g. the /b and /c match have a common //v match).

For each linear XPath in the query, we will also create XML Index Entries. For the linear XPaths

1. //x[.//v[b=“b”]], we will create XML Index entries based on the XPath //x//v/b,

2. //x[.//v[c=“c”]], we will create XML Index entries based on the XPath //x//v/c,

3. //x[.//a=“a”], we will create XML Index entries based on the XPath //v//a.

Entries for the XML Indexes are shown below, in Table 2. The fields in each entry contain:

1. Path—the unique path that matched some linear XPath,

2. Value—the value of the last document node in the path,

3. DocID—the document id of the XML document that contains the Path in (1),

4. NodeID—the id of the node in the XML document that is in the Path in (1).

TABLE 2
XML Index Entries

| Path | Value | DocID | NodeID |
|---|---|---|---|
| z-e-x-p-v-b | “b” | doc1 | 1.1.1.2.1.1.1 |
| z-e-x-p-v-b | “b” | doc2 | 1.1.1.1.1.1.1 |
| z-e-x-p-v-b | “b” | doc3 | 1.1.1.1.1.2.1 |
| z-e-x-p-v-c | “c” | doc1 | 1.1.1.2.1.1.2 |
| z-e-x-p-v-c | “c” | doc3 | 1.1.1.1.2.1.1 |
| z-e-x-p-v-c | “c” | doc4 | 1.1.1.1.1.1.1 |
| z-e-x-p-v-c | “c” | doc5 | 1.1.1.1.1.1.1 |
| z-e-x-p-a | “a” | doc5 | 1.1.1.1.1.2 |
| z-e-x-q-v-b | “b” | doc2 | 1.1.1.1.2.1.2 |
| z-e-x-q-v-b | “b” | doc4 | 1.1.1.1.2.1.1 |
| z-e-x-q-v-c | “c” | doc2 | 1.1.1.1.2.1.1 |
| z-e-x-q-v-c | “c” | doc5 | 1.1.1.1.2.1.1 |
| z-e-x-q-a | “a” | doc2 | 1.1.1.1.3.1 |
| z-e-x-q-a | “a” | doc3 | 1.1.1.1.3.1 |
| z-e-x-q-a | “a” | doc5 | 1.1.1.1.2.2 |
| z-f-x-p-v-b | “b” | doc1 | 1.1.2.1.1.1.1 |
| z-f-x-p-v-c | “c” | doc1 | 1.1.2.1.1.1.2 |
| z-f-x-p-a | “a” | doc5 | 1.1.3.1.1.1 |
| z-f-x-q-v-b | “b” | doc5 | 1.1.3.1.2.1.1 |
| z-f-x-q-v-c | “c” | doc5 | 1.1.3.1.2.1.2 |
| z-f-x-q-a | “a” | doc4 | 1.1.2.1.1.1 |

The XML Index Entries record Path, Value pairs where the Path describes some Path in some XML document, and the value of the node (as a result of Atomization) at the end of the Path. The DocID refers the XML document containing the path, and NodeID refers to the location of the node at the end of the Path. The XML Index Entries describes the XML documents that have some Path and Value in ascending DocID and NodeID order.

Refer now to FIG. 1 in order to explain nodeIDs. For document 1 (10), we see that node ‘z’ (12) has nodeID 1.1, based on steps from the root node ‘doc’ (11). Similarly, node ‘e’ (13) has nodeID 1.1.1, node ‘x’ (14) has nodeID 1.1.1.2 (because node ‘aa’ has nodeID 1.1.1.1), node ‘p’ (15) has nodeID 1.1.1.2.1, node ‘v’ (16) has nodeID 1.1.1.2.1.1, and node ‘b’ (17) has noded 1.1.1.2.1.1.1. It is important to note that nodeIDs are equivalent to preorder traversal numbers for a document and can therefore be used to represent order in the nodes. The nodeID 1.1 is numerically less than nodeID 1.1.2, which is numerically less than nodeID 1.1.2.1, and so on. Therefore, it should be apparent to those skilled in the art that parent nodeIDs can be easily computed from each descendant nodeID. For example, the nodeID of node ‘x’ (14), 1.1.1.2, can be computed from the nodeID of node ‘b’ (17), 1.1.1.2.1.1.1, by truncating the nodeID from 7 digits to 4 digits. The numbers in a nodeID represent a serial number for the node on that particular level of the hierarchy and each successive dot indicates a lower level in the hierarchical tree.

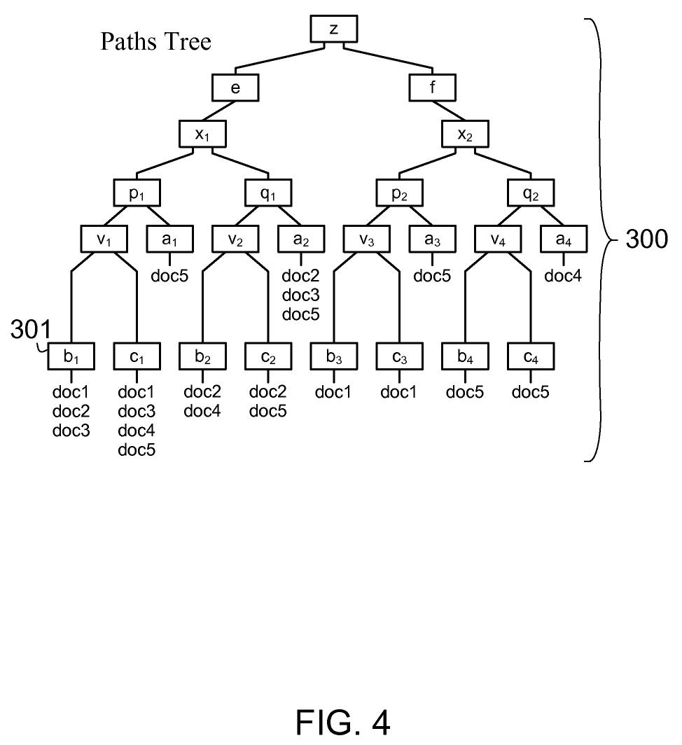

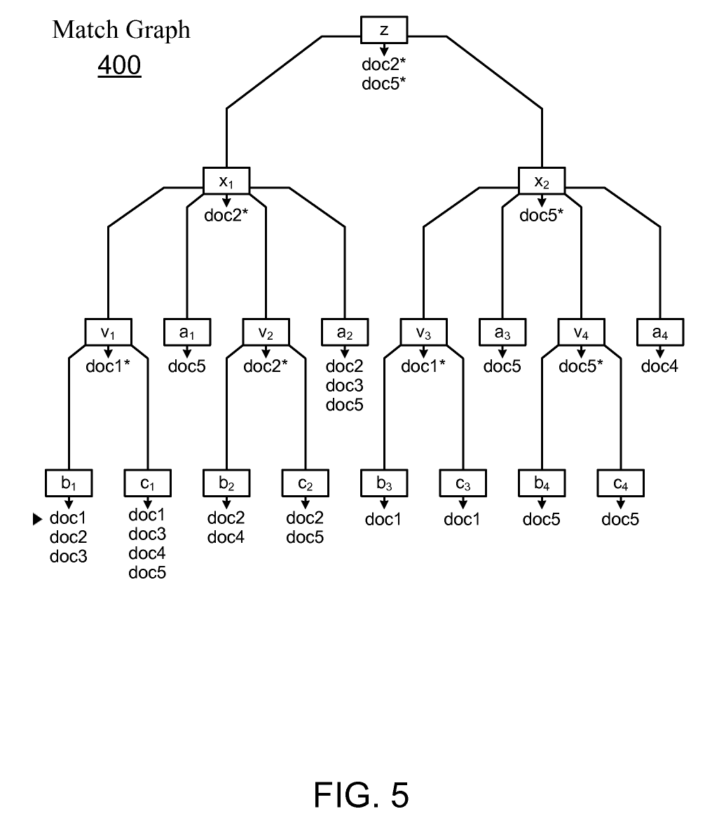

The XML Index Entries, shown in Table 2, relate to locations within the collection of XML documents, shown in FIGS. 1 and 2. Referring now to FIG. 4, Paths Tree 300 shows that there are a plurality of matching paths that correspond to linear XPath //x//v/b. The first entry in Table 2, z-e-x-p-v-b, corresponds to the first matching path. The labels within each path, in Paths Tree 300, are subscripted with numbers to show the unique instances of that label within paths. For example, labels within the path z-e-x-p-v-b are subscripted with ‘1’; this first path is shown in Paths Tree 300 as z-e-x₁-p₁-v₁-b₁. Subsequent matching paths are labeled with the subscripts 2, 3, etc; the second path is shown in Paths Tree 300 as z-e-x₁-q₁-v₂-b₂, where ‘v₂’ indicates that this ‘v’ path is the second unique path for //v, and b₂ indicates that this ‘b’ path is the second unique path for /b.

Refer now to FIG. 4 and Table 2, above. The first XML Index Entry indicates that the b₁ path 301 has the value ‘b’ at doc1 at nodeID 1.1.1.2.1.1.1. Note that for the b₁ path, there are a number of XML Index entries. The first b₁ entry points to document 1, nodeID 1.1.1.2.1.1.1. The second b₁ entry points to document 2 nodeID 1.1.1.1.1.1.1. Therefore, the Indexes can locate the b₁ paths in documents 1 and 2.

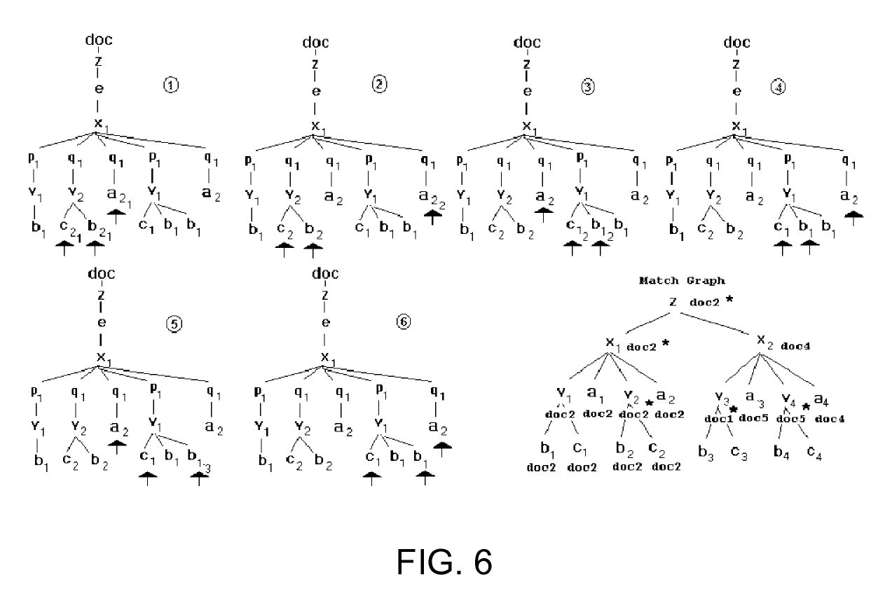

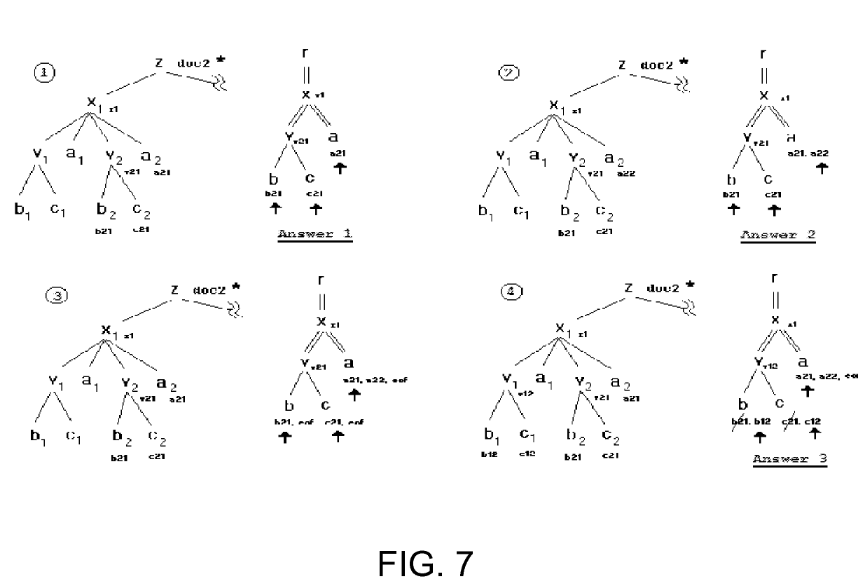

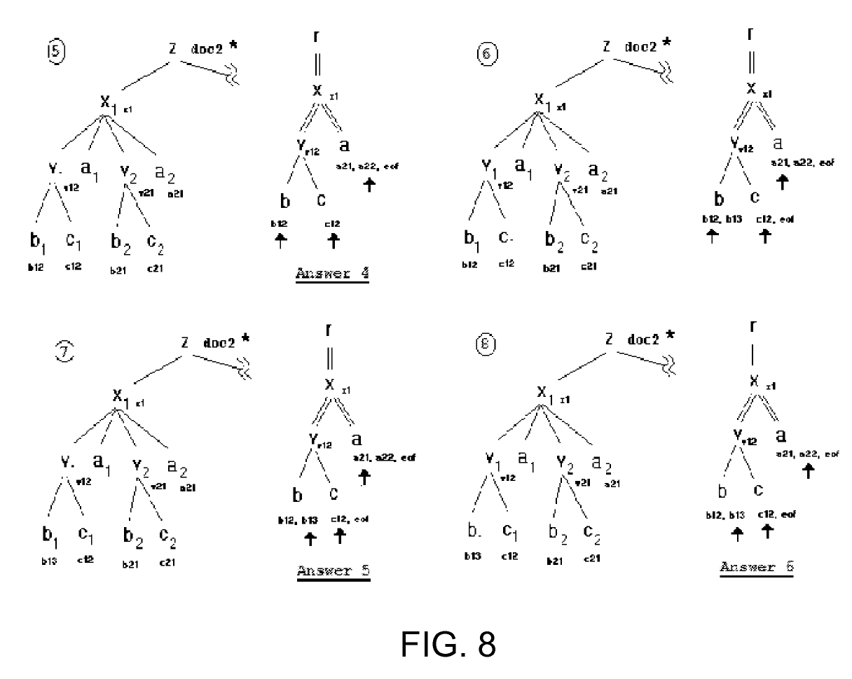

FIGS. 6 and 7 show the matching paths subscripted along the XML Documents. FIG. 6 shows post-match Document 1 (610), post-match Document 2 (620), post-match Document 3 (630), and post-match Document 4 (640). FIG. 7 shows post-match Document 5 (650). This will make it easier for those skilled in the art to imagine Index Cursors pointing to the XML Indexes that refer to some b₁ path in document 1, and another Index Cursor pointing to some c₂ path in document 2, and so on.

Using the illustration above for example, we can easily see the matches for the linear XPath //x//v/b. That is, we have the matching paths b1 at document 1, b3 at document 1, b1 at document 2, and so on. For the linear XPath //x//v/c, we have the matching paths c1 at document 1, c3 at document 1, c2 at document 2, and so on. For the linear XPath //x//a, we have the paths a2 at document 2, a2 at document 3, a4 at document 4, and so on. We will then describe the way the Pivot Join method advances the XML Index Cursors by saying that the b1 Index Cursor is currently at the first b1 in document 1, then at the first b1 at document 2 and so on.

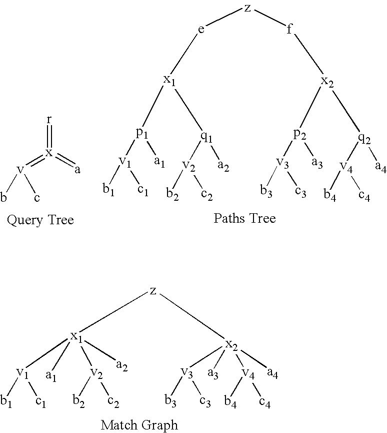

We noted earlier that the Paths Tree shows that there may be some paths that share some ancestor path with other paths. The Pivot Join discovers whether documents do have paths that share ancestor paths by remembering Locations of Paths within the XML documents. The Pivot Join does this using the Match Graph. From the Query Tree and the Paths Tree above we can construct the Match Graph.

The Match Graph is constructed from the Query Tree and Paths Tree by finding paths in the Paths Tree that match Steps in the Query Tree. The b1 node in the Match Graph for example signifies the match between the b1 Path in the Paths Tree and the ‘/b’ step in the Query Tree. The Match Graph is used to remember document and node locations while performing the XML Index Cursor scans. For example, if we advance the index scan for b1 and it returns document 1 and nodeID for the first b1 in document 1, we will remember that the location, document 1 and the nodeID for the b1 match in the Match Graph node b1.

We say that the Match Graph node b1 is at location document 1 and nodeID of the b1 node in document 1.

Note that the non-leaf nodes in the Match Graph such as v1, v2, and x1 also contain location information for the //v, //v and //x matches respectively and their locations come from the truncated locations of their descendant leaf match nodes.

For the sake of brevity in the following discussions, we will sometimes omit saying what nodeID we are at in the match graph nodes, because the reader can easily see which document nodes are being referred to in the XML Documents diagram. Pivot Join uses one Index Cursor for each leaf in the Match Graph. Each leaf node in the Match Graph refers to a unique path that matched a linear XPath in the query tree. So the b1 match has one Index Cursor, c1 path has one Index Cursor; b2 path has one Index Cursor, and so on. This allows us to advance each Index Cursor for their respective Path entries in the Index in docID, nodeID order.

Now that we've described the Paths Tree and the Match Graph, we will describe how Pivot Join works. The following examples show snapshots of the Match Graph and describe how Locations (based on docID and nodeID) are computed.

We will show how the index scans are advanced based on the locations computed and we will use the XML Documents Diagram below to help track what the Index Cursors are pointing to.

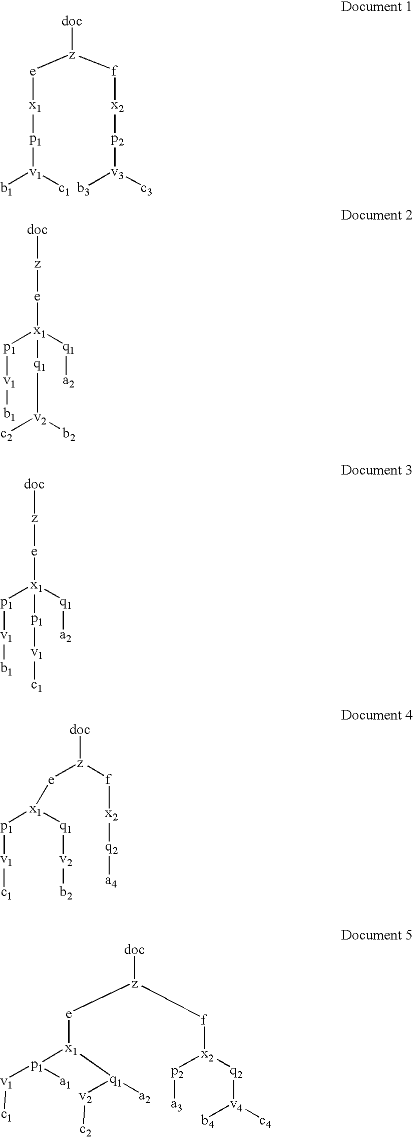

The snapshots of the Match Graph below progress from left to right. The leaves of the Match Graph correspond to index scans. In the Match Graph snapshot to the left, the b1 index scan is at doc1 (document 1). The c1 index scan is also at doc1. b2 at doc2, c2 doc2. a1 at doc5 and so on. The locations in the match graph nodes show that the b1 index scan is at document 1, the c1 index scan is at document 1, the b2 index scan is at document 2, the c2 index scan is at document 2, the al index scan is at document 5, and so on. The reader should be able to follow the index scans by referencing the XML Documents Diagram above. Although not shown in the diagram, the b1 match node not only remembers that it is currently at doc 1, but also that it is at the first b1 path in document 1 using that b1's nodeID. Again, for brevity, we won't mention the nodeID part of the location where it is obvious from the XML Documents Diagram.

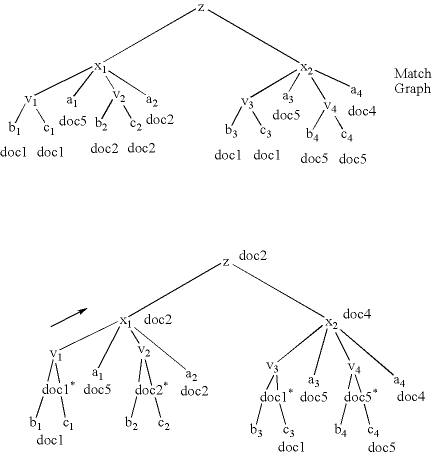

Given the locations computed for the leaves of the Match Graph above, we now need to compute for the locations of the ancestor match nodes. The XML Pivot Join Algorithm does this by computing the locations of the ancestor match nodes bottom up. That is, we need to compute for the location of v1 above the b1 and c1, and then later x1 above the v1, and so on. We compute for the locations of the ancestors by truncating the nodeIDs of their descendant match nodes to the levels of the ancestors match node, and applying the following rules.
1. If the truncated nodeIDs of the descendants match nodes (as well as their docIDs) are equal, assign that location (docID and nodeID pair) to the ancestor match node, and say that the ancestor match node is ‘exact’.
2. If the truncated nodeIDs (and their docIDs) of the descendants are not equal, we take the maximum location (docID and nodeID) of the descendants and assign that to the ancestor match node, then say that the ancestor match node is NotExact. This is referred to as an ‘ANDing’ operation at the ancestor match node, and the notion is that if the descendant matches are at different locations at the ancestor, it means that the descendant matches have different ancestors currently. So to find a match, we need to advance one of the descendants to at least the location of the ancestor of the descendant that has a higher (docID, nodeID) location.
3. If there are more than one descendant match for the same descendant step, as in the case for x1 because it has two ‘v’ descendants in v1 and v2, then we take the minimum location of the descendants first before applying rules 1 and 2. This is referred to as an ‘ORing’ operation at the ancestor match node.

In the Match Graph snapshot to the right, we truncated b1's nodeID location to v1's level and find that the nodeID equals the nodeID computed by truncating the nodeID of c1 to v1's level. We also find that the docIDs for b1 and c1 are equal. So we are Exact at v1. We depict this condition with an asterisk (*) at v1 (rule 1). This reflects the fact that a b1 path and a c1 path have the same v1 ancestor in document 1. Here v1's nodeID is the truncated nodeID of b1 at doc1. We can derive the same discussion for v2.

To compute for x1's location, we take the min of (a1, a2) and min(v1, v2) (rule 3), then apply rule 1 or rule 2. Just considering the docIDs for now, we can see that (min(a1,a2), min(v1, v2)) is equal to (min(doc5,doc2), and min(doc1, doc2)) is equal to (doc2, doc1). Because doc2 is not equal to doc1, we take the maximum (rule 2), so x1 is now at doc2 with a2's nodeID truncated at x1's level.

We show in the snapshot to the right, that x1's location is doc2 and that x1 is NotExact (represented by the absence of the asterisk (*)). To compute for z's location, we take the min of (x1 and x2), so z is at doc2 and is NotExact. z represents the location of the first element of the document. Because z is NotExact, we need to try to advance the cursors again until z becomes Exact. If z becomes Exact, it means we've found a XML document that matches the XPath query. Given rules 1, 2, and 3, z can only become Exact if some path along the Match Graph from descendant matches to z are all Exact.

To advance the cursors, we Pivot at the z match node (which happens to be the minimum location for the z step) by incrementing the location of z to a location just before the next sibling of z. Intuitively, since each match node is a match of a step at a specific level, the next possible match for z at that level would have to be its next sibling. The Pivot at the z match node is depicted below with the plus sign+next to the doc2 location at the z match node. The Pivot is computed so that some index cursors can advance beyond their current locations. Next the b1 index cursor will be advanced from its current location. Specifically, the next location of b1 will be computed by taking the maximum of all b1's ancestor matches, after taking the minimum of matches for the same step, which is max location of (b1, min(v matches), min(x matches ), and z+), which is max(b1, v1, x1, z+)==z+.

Using z+ as the key for the index lookup on b1, we will get doc3 as the next location for b1.

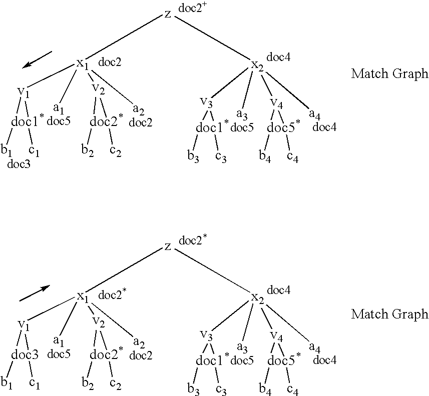

The match graph above and to the left now, shows that we advanced the b1 index cursor to doc3 (specifically we advanced b1 to the first b1 at doc3). By advancing b1 to doc3, and then applying the algorithm described to get locations for ancestor match node locations (rules 1-3), we can derive the match graph to the right and we're now able to find a match at x1 in doc2. That is, we've found a b2 path and a c2 path with the same v2 ancestor, and the v2 and a2 has the same x1 ancestor at document 2. In this case, z will be Exact. The doc2 location computed at z is the first match for the query //x[ .//v[b and c] and .//a ]. This can be easily confirmed with the Documents Diagram below.

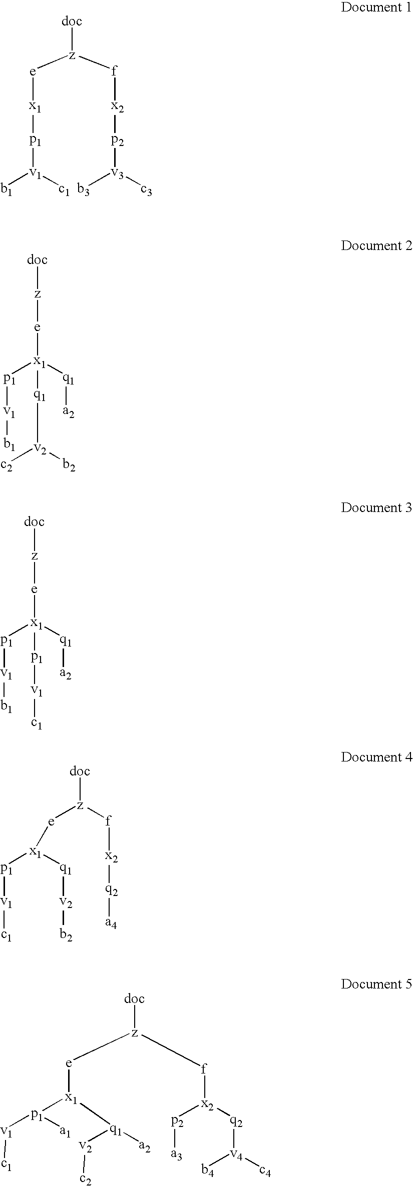

After we've returned our first answer (doc2), we can again Pivot at z and advance the cursors as depicted below with the match graph to the left. After advancing some cursors, some locations will reach end-of-file (EOF) as depicted with b3, v3, and c3 as they've moved past doc1 which is the last document where these paths exist. For the purpose of computing the locations, EOF is always higher than any location. After advancing a4's location beyond doc4 as depicted in the match graph to the right, we find an Exact in x2 and z in document 5. This is the second match of for the query //x[ .//v[b and c] and .//a] found in document 5.

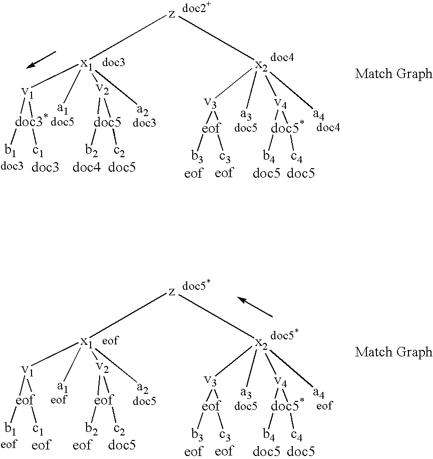

As shown in the discussions above, XML Pivot Join takes the index cursors to the first locations within XML Documents that satisfy the query, then returns the docID of the document that qualified using the first match node in the match graph (the z match node). (In fact, it is the docID and the nodeID of the z match node that is returned. But since there should only be one z in the XML document, we are effectively just returning the docID of the XML document.). In the previous examples, we returned doc2, and then doc5 using the location stored in the z match node. After we return the docIDs of qualifying documents, we Pivot at the z node and advance the cursors again to look for the next qualifying document. XML Pivot Join allows us to perform inter-document filtering for a collection of XML documents.

### XML Pivot Join (Extended)

The present invention extends the state of the art beyond the XML Pivot Join procedure described above in order to enable intra-document level filtering and to return multiple locations as tuples of locations within a document. For example, consider the sample XQuery FLWOR expression of Expression 2.

for $x in doc( )//x Expression 2:
for $v in $x//v
   for $b in $v/b[.=“b”]
   for $c in $v/c[.=“c”]
   for $a in $x//a[.=“a”]
return <result>{$b, $c, $a}</result>

Assume that an XML document has been preselected from a collection of XML documents based on its containing at least one subtree that matches the sample XQuery. One particularly suitable method for accomplishing such a preselection has been described above.

In order to find all matching sub-trees within the preselected XML document, the ‘pivoting’ procedure described above is modified so that the procedure pivots at specific match nodes that correspond to matches to step nodes in the XQuery rather than pivoting at the z match node so we can avoid jumping ahead to the next matching document. For example, in the FLWOR expression shown in Expression 2, the step nodes in the query are the //x, //v, /b, /c and //a steps. The match graph for this query can have multiple Match Nodes corresponding to unique paths that match the //x, //v, /b, /c, and //a steps. In the following discussions, forward binding order refers to the order specified in the query (read top to bottom and left to right), which is //x, //v, /b, /c and then //a. Reverse binding order then is //a, /c, /b, //v, //x.

To show that the algorithm works, we will first show how the index scans need to be positioned within the xml document so that we can return the correct results. Referring first to FIG. 6, we see that the first /b, /c, and //a matches are pointed to by the index cursors. The a2 cursor is pointing to the first $a binding under the first $x binding. This ‘//a’ match is labeled a21 to say that this is an a2 path, and it is the 1st //a match in the document. The c2 cursor is pointing to c21, and the b2 cursor is pointing to b21, and c21 and b21 are under v21, the first $v binding for the document. To produce the second result (2), the cursor a2 needs to point to a22, while the other cursors stay where they are. For the third result (3), we need to rewind back to the first ‘//a’ match a21, while the b1 and c1 cursors point to b12 and c12 respectively. For the fourth result (4), we again advance the ‘//a’ match to a22. To produce the fifth result (5), we need to rewind the ‘//a’ match back to a21, while we position b1 to b13. The sixth result (6) is produced by advancing the ‘//a’ match to a22.

In the following discussions, we will explain how we advance the index scans corresponding to match nodes. For example, to advance the index cursor for a2, we will say that we will Pivot a2 to some location. This location will be expressed either as (a21+<Pivot<x1+) or (x1<Pivot <x1+). To explain this notation, a21 means the a2 path in the document that is the 1st match for the //a step. a21+then means the location just before the next sibling of the a21. (a21+<Pivot <x1+) means that Pivot is a location greater than the location just before the next sibling of a21, but less than the location just before the next sibling of x1. In other words, Pivot is the location after a21 but under x1, which we will use to find the next //a match under the //x match. (x1<Pivot <x1+) means that Pivot is a location after x1 but before the location before the next sibling of x1. In other words, Pivot is the location under x1 but not after x1, which we will use to find the first //a match under a //x match. Note that FIG. 6 illustrates a Pivot Join showing the first /b, /c, and //a matches in document 2.

Refer now to FIG. 7 which shows, in reverse binding order, Pivoting on the matches for the //a Step under the current //x match. This means we will Pivot either a21 or a22 under x1 to (a21+<Pivot<x1+). FIG. 7 shows, in Answer 2, that we advanced a2 to a22. Accordingly, we can return the second result.

To obtain Answer 3, we Pivot the //a matches to (a22+<Pivot<x1+). Since there are no more //a matches under x1, we get End-of-File (EOF) for //a. Because we got EOF we will now Pivot the next step in reverse binding order, which means we will Pivot on /c matches. We will now Pivot on /c matches under the //v match v21. We will Pivot c2 to (c21+<Pivot<v21+). There are no more /c matches under v21 so we get EOF for the /c step. The next step in reverse binding order is /b so we will now Pivot in /b matches under v21. We will Pivot b2 to (b21+<Pivot<v21+). Again there are no more /b matches under v21 so we get EOF for the /b step. Next in reverse binding order is the //v step. To Pivot on the non leaf step //v (which means we're pivoting on either v1 or v2 matches under the x1), we need to Pivot on any of the //v descendant leaf matches (the matches for /b and /c steps). This includes b1, c1, b2, and c2 in the match graph. To Pivot //v means we will Pivot on any of b1, c1, b2, c2 to (v21+<Pivot<x1+).

Referring now to FIG. 3, Answer 4 is obtained when b1 is advanced to b12 which advances v1 to v12. Since we advanced the //vmatchv1 to anon-EOF location (v12), we will now Pivot in forward binding order. We just advanced the /b step so the next step in binding order is /c. In (4), cl is Pivoted to (v12<Pivot<v12+) which positions c1 to c12. If we pivoted c1 to (v12 <Pivot<v12+) and reached EOF, meaning there is no c1 under the v12, then we go back Pivoting in reverse binding order. The next step in forward binding order is //a where a2 is Pivoted to (x1<Pivot<x1+) which positions a2 back to a21. Accordingly, we can return the third result.

In (5), in reverse binding order, we will Pivot on the matches for the //a Step under the current //x match. So we will Pivot a2 to (a21+<Pivot<x1+). In (5), we can return the fourth result. In (6) we pivot a2 and reach EOF then pivot c1 and reach EOF. In (7) we pivot b1 and reach b13. Because b13 is non-EOF, we will now pivot in forward binding order and pivot /c and //a matches. In (7), we position c1 and a2 to c12 and a21 respectively. In (7) we can return the fifth result. In (8), in reverse binding order, we pivot a2 to a21, and we can return the sixth result.

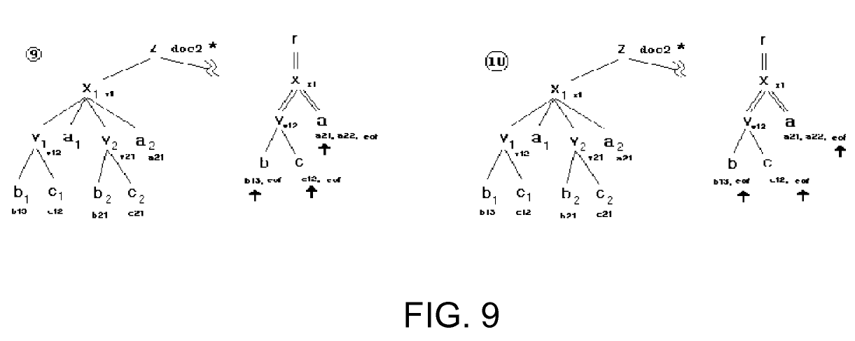

Refer now to FIG. 9. In (9) based on reverse binding order we will pivot a2 and reach EOF, pivot c1 and reach EOF, pivot b1 and reach EOF. When we pivot v1 to (v12+<Pivot<x1+), there are no more //v matches under x1, so v1 also reaches EOF. We will now pivot on //x matches. x1 will be pivoted to (x1+<Pivot<z+) and since there are no more x1 in document2, x1 reaches EOF. Since //x is the last step in reverse binding order, we are finished with the document, and have found all the matches within it for this particular query. We can proceed with Inter-document Pivot Join again to find the next matching document.

Based on the descriptions of the algorithm for Multiple Extractions Pivot Join, we outline the observations listed below.

First Observation: When Pivoting the matches in reverse binding order, we advance the matches to a location > the location before its next sibling and < the location before the next sibling of the current ancestor match. Note that advancing the matches to the XML Pivot Join may advance a match beyond the location of another match for the same step, and if this is the case, we always take the minimum location after the Pivot (you can see this happening with //v matches above when we Pivoted to v12 from v21, which could have been because the next location of v2 is > than that of v1 but still under the same x1, rather than v2 reaching EOF).

The ancestor match to consider here is the least common FOR ancestor step match. In this query for example, ‘for $a in doc( )/a, for $b in $a/b, for $c in $b/c return <r>{$b, $c}</r>’, /c's least common FOR ancestor is /b, but for ‘for $a in doc( )/a let $b in $a/b, for $c in $b/c return <r>{$b, $c}</r>’, /c's least common FOR ancestor is /a.

Second Observation: When Pivoting the matches in forward binding order, we advance the matches to a location ‘greater than’ (>) the location of the current ancestor match and less than (<) the location before the next sibling of the current ancestor match. The ancestor match to consider here is again the least common FOR ancestor step match. This produces the rewinding required in the query as the query finds the first match of a step under the ancestor step.

Third Observation: When Pivoting in forward binding order, if the index lookup reaches EOF, we need to reverse directions and do Pivoting in reverse binding order. This intuitively makes sense because we need to find other bindings based on previous bindings.

Fourth Observation: When Pivoting in reverse binding order, if the index lookup reaches EOF, we need to continue Pivoting in reverse binding order until the index lookup doesn't reach EOF, then we reverse directions and do Pivoting in forward binding order. If we reach the last step in reverse binding order and still reach EOF, we are done with intra-document Pivot Join. We can switch to doing inter-document Pivot Join again by Pivoting at the first element match of the document.

Fifth Observation: This intra-document filtering procedure can advantageously be accomplished immediately after an inter-document Pivot Join. For example, we can immediately start Pivoting in reverse binding order.

Sixth Observation: The Match Graph provides a very efficient mechanism for choosing which index scans to Pivot on to find the next results for a query. For example, when pivoting /b matches under a current //v match say v1, only b1 needs to be pivoted and not b2 because b2 belongs to a different //v match which is for a different v path.

In a further embodiment of the present invention, Recursive Matches within the preselected XML document are handled. Recalling Expression 2, our example XQuery expression:

for $x in doc( )//x Expression 2
for $v in $x//v
   for $b in $v/b[.=“b”]
   for $c in $v/c[.=“c”]
   for $a in $x//a[.=“a”]
return <result>{$b, $c, $a}</result>

Those skilled in the art will appreciate that there will be cases where there are multiple current ancestor matches to consider, during intra-document level filtering. This happens when there are descendant steps in the query and the matching document has recursive tags in them as in the case below for the ‘x’ tag.

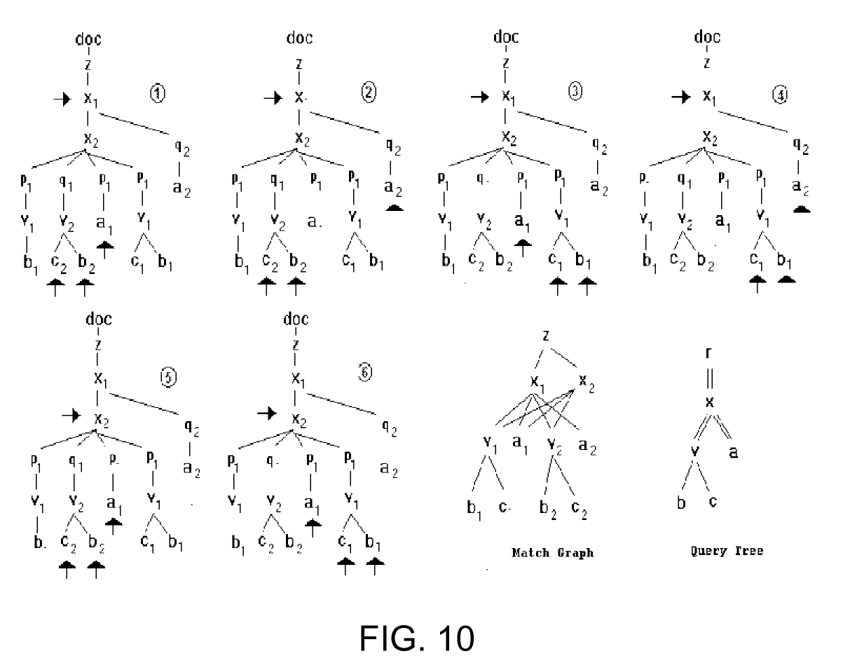

Refer now to FIG. 10. Using the query above, the index cursors need to be positioned as shown below, first for x1, and then for x2. Notice in (5) and (6) that a2 is not part of the result set for x2 as it is not under x2.

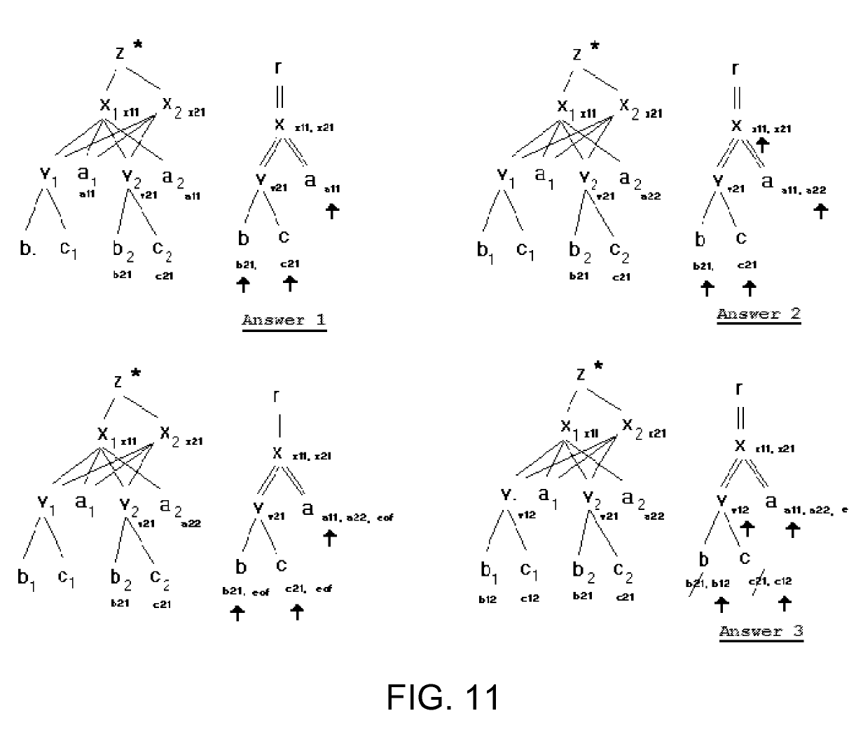

The Match Graph for the document depicted in FIG. 10 is illustrated in FIG. 11. v1, a1, and v2 now have 2 parent matches, x1, and x2. Just after inter-document level filtering, there will be two match nodes for the //x step that are Exact. These are the match nodes x1 and x2. Reflected in the Step Tree node for //x is the fact that there are 2 locations for //x corresponding to the 2 match nodes x1 and x2. The locations are labeled x11, x21. Because x21 location is greater than x11, Intra-document level filtering works as before and the //x ancestor matches that are Exact will to be considered one at a time.

As shown in FIG. 6, the first sets of results will be computed based on x11, and then for x21. For the first //x match location x11, we have 4 answers to return.

Right after Answer 4, we will reach EOF when we pivot at v1, so the next binding to Pivot in reverse binding order are the matches for //x. Since there are currently 2 //x matches, we will Pivot from x11 to x21 for the //x step based on the Pivot (x11+<Pivot<z+). x1 will reach EOF but x21 will be the new minimum match for //x step.

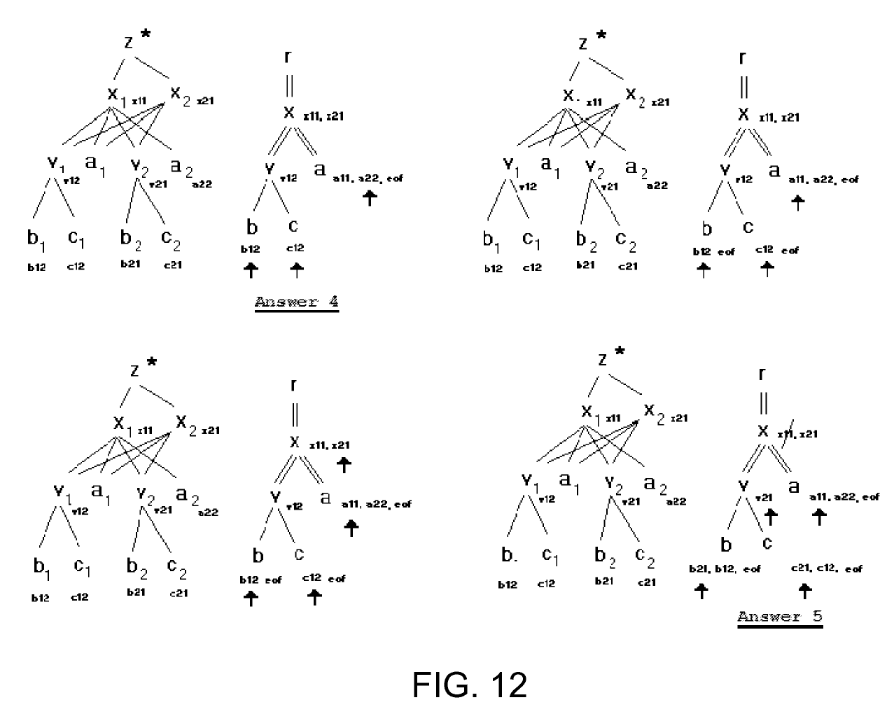

Refer now to FIG. 12. The next two results are then computed based on x21. Note that previously we used the same Pivot but since there is only one //x match for that document, that we reached EOF for //x.

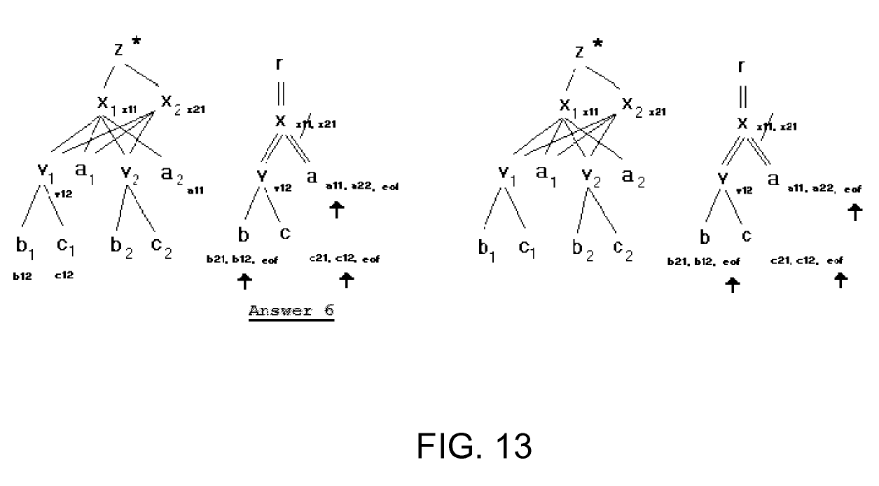

Refer now to FIG. 13. Notice for Answer 6, shown in FIG. 7, that because the ancestor match for //a is x21, that we can only Pivot the //a matches to a11 and not to a22 because a22 is not under x21. This action is shown in FIG. 13.

In yet a further embodiment of the present invention, Sequences and EOE Issues within the preselected XML document are handled. Again recalling Expression 2, our example XQuery expression:

for $x in doc( )//x Expression 2
for $v in $x//v
   for $b in $v/b[.=“b”]
   for $c in $v/c[.=“c”]
   for $a in $x//a[.=“a”]
return <result>{$b, $c, $a}</result>

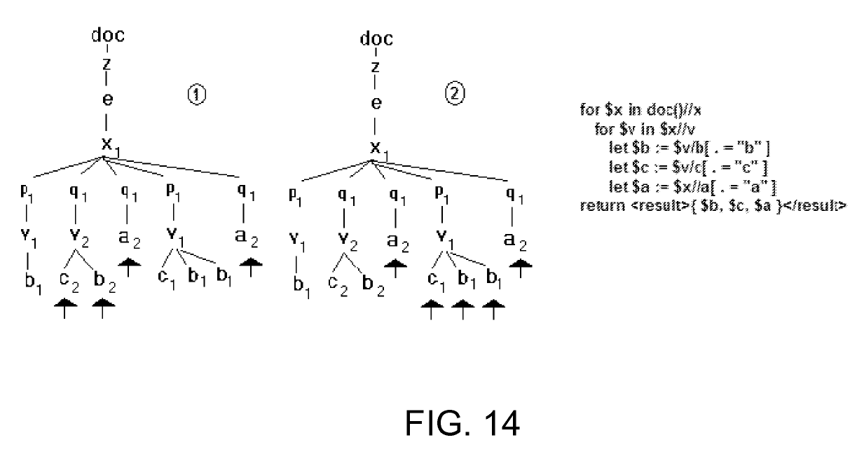

Refer now to FIG. 14. Previous examples show FOR bindings only. In the query above, the /b, /c, and //a matches are for LET bindings $b, $c and $a respectively. As shown in (1) and (2), for every //v match under the //x match, we need to return the sequence of /b, /c and //a matches. To handle this query, we will modify the algorithm slightly. First, we will treat all the bindings as if they are FOR bindings. So the algorithm proceeds as before. But instead of returning, we will do an additional pass in forward binding order and for every LET binding encountered, we will Pivot (using forward binding order pivot rules) until we reach EOF for each LET binding. This enables us to gather the sequences of matches for the LET bindings under the current FOR bindings and to buffer up the locations into sequences. That is, for the first result above, we will gather the sequence of locations a21 and a22 for the //a step under the current //x FOR binding, and c21 and b21 for the /c and /b steps respectively under the current //v FOR binding. For the second result above, we will gather the sequence of locations a21, a22 for the //a step, c12 and b12, b13 for the /c and /b steps respectively.

Note that we can only do this for queries that do not require EOE (empty on empty) semantics. That is, if there are no /b matches under a //v match for example, and we still want to return the /c matches under the //v (resembling outer join semantics) then we cannot use XML Indexes (and Pivot Join for that matter) to answer those queries.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having: computer usable program code programmed to filter a collection of XML documents for documents that satisfy an XQuery FLWOR expression and extract document nodes referred to by the XPath expressions in the XQuery FLWOR expression and honoring binding order specified in the XQuery FLWOR expression, the computer program product having operations comprising:
providing an XML index of node paths for a collection of XML documents and an XQuery FLWOR expression having a plurality of “FOR or LET” bindings, the plurality of “FOR or LET” bindings further comprising one or more “FOR” and one or more “LET” bindings;
generating a path tree and a match graph according to the XQuery FLWOR expression, based on a set of linear XPaths identified in the XQuery FLWOR expression and a set of node paths in the collection of XML documents that match steps of the linear XPaths in the set of linear XPaths;
positioning a plurality of index cursors, each index cursor pointing to a match for a linear XPath step, each match represented by a match node in the match graph, each match referring to a document node location in the collection of XML documents, including an inner cursor and an outer cursor, where each one of the plurality of cursors points to a match corresponding to one of the plurality of “FOR or LET” bindings in the XQuery FLWOR expression;
returning, as a first result set, the node locations pointed to by the cursors;
advancing the inner cursor along the match graph, the inner cursor selected in reverse binding order;
in response to the advancing inner cursor pointing to a step match for an inner-most “FOR or LET” binding of the XQuery FLWOR expression,
returning, as a subsequent result set, the node locations pointed to by the cursors, and
continuing to advance the inner cursor; and
in response to the advancing inner cursor and not finding additional step matches,
advancing an outer cursor along the match graph until the outer cursor either points to a step match for a next outer “FOR or LET” binding of the XQuery FLWOR expression or finds no such step matches, the outer cursor selected in reverse binding order,
in response to the advancing outer cursor pointing to a step match,
advancing, in forward binding order, the inner cursor along the match graph until the inner cursor either points to a step match for a next nested “FOR or LET” binding of the XQuery FLWOR expression or finds no further such step matches,
in response to the advancing inner cursor pointing to a step match,
returning, as a subsequent result set, the node locations pointed to by the plurality of cursors, and
continuing to advance the inner cursor, and
in response to the advancing inner cursor reaching the end of the match graph without finding an associated step match and the advancing outer cursor reaching the end of the match graph without finding an associated step match and with no other cursors being defined, returning an indicator that all results have been returned.

2. A computer program product comprising a computer readable medium having computer usable program code programmed to filter a collection of XML documents for documents that satisfy some XQuery FLWOR expression, the computer program product having operations comprising:
providing an XML index of node paths for a collection of XML documents, where the collection includes the preselected XML document;
generating a match graph according to the XQuery FLWOR expression for the preselected XML document, based on the XML index, where the match graph includes leaf nodes with each leafnode corresponding to a binding at the innermost binding level of the preselected XML document;
positioning a plurality of cursors, including a first and second cursor, in the match graph, where each one of the plurality of cursors points to a node location within the match graph corresponding to a “for” binding in the XQuery FLWOR expression at the innermost binding level;
returning, as a first result set, the node locations pointed to by the plurality of cursors;
advancing, in reverse binding order, a first cursor along the match graph until the first cursor either points to a step match for a next outer “for” binding of the XML FLWOR expression or reaches the end of the match graph without finding such a step match,
when the advancing first cursor is found to be pointing to a step match, then returning, as a subsequent result set, the node locations pointed to by the plurality of cursors and continuing to advance the first cursor;
advancing, in reverse binding order, a second cursor along the match graph until the second cursor either points to a step match for a next outer “for” binding of the XML FLWOR expression or reaches the end of the match graph without finding such a match,
when the advancing second cursor is found to be pointing to a step match, then returning, as a subsequent result set, the node locations pointed to by the plurality of cursors and continuing to advance the second cursor;
advancing, in forward binding order, a first cursor along the match graph until the first cursor either points to a step match for a next nested “for” binding of the XML FLWOR expression or reaches the end of the match graph without finding such a step match,
when the advancing first cursor is found to be pointing to a step match, then returning, as a subsequent result set, the node locations pointed to by the plurality of cursors and continuing to advance the first cursor; and
advancing, in forward binding order, a second cursor along the match graph until the second cursor either points to a step match for a next nested “for” binding of the XML FLWOR expression or reaches the end of the match graph without finding such a match,
when the advancing second cursor is found to be pointing to a step match, then returning, as a subsequent result set, the node locations pointed to by the plurality of cursors and continuing to advance the second cursor.

3. The computer program product of claim 2 wherein the operations further comprise:
advancing, in reverse binding order, a third cursor along the match graph until the third cursor either points to a step match for a next outer “FOR or LET” binding of the XML FLWOR expression or reaches the end of the match graph without finding such a step match,
when the advancing third cursor is found to be pointing to a step match, then returning, as a subsequent result set, the node locations pointed to by the plurality of cursors and continuing to advance the third cursor; and
advancing, in forward binding order, a third cursor along the match graph until the third cursor either points to a step match for a next nested “for” binding of the XML FLWOR expression or reaches the end of the match graph without finding such a step match,
when the advancing third cursor is found to be pointing to a step match, then returning, as a subsequent result set, the node locations pointed to by the plurality of cursors and continuing to advance the third cursor.
